(19) United States
(12) Patent Application Publication
(10) Pub. No.: US 2022/0221712 A1
(43) Pub. Date: Jul. 14, 2022

(54) OPTICAL DEFLECTION APPARATUS AND IMAGE PROJECTION APPARATUS

(71) Applicant: Tsukasa YAMADA, Tokyo (JP)

(72) Inventor: Tsukasa YAMADA, Tokyo (JP)

(73) Assignee: MITSUMI ELECTRIC CO., LTD., Tokyo (JP)

(21) Appl. No.: 17/646,923

(22) Filed: Jan. 4, 2022

(30) Foreign Application Priority Data
Jan. 8, 2021 (JP) 2021-002102

(51) Int. Cl. G02B 26/10; H04N 9/31

(52) U.S. Cl. CPC G02B 26/101; G02B 26/0858; H04N 9/3135

(57) ABSTRACT

An optical deflection apparatus includes a first optical deflection part configured to deflect light incident on a first reflection surface, by swinging the first reflection surface about a first swing axis, and a second optical deflection part configured to deflect the light deflected by the first reflection surface, by swinging a second reflection surface about a second swing axis crossing the first swing axis. The first swing axis crosses a first incidence plane including a central axis of the light incident on the first reflection surface and a central axis of the light deflected by the first reflection surface, and the second swing axis crosses a second incidence plane including a central axis of the light incident on the second reflection surface and a central axis of the light deflected by the second reflection surface.

### CROSS-REFERENCE TO RELATED APPLICATION

This application claims priority under 35 U.S.C. § 119 to Japanese Patent Application No. 2021-002102, filed Jan. 8, 2021, the content of which is incorporated herein by reference in its entirety.

### BACKGROUND

### 1. Field of the Invention

The present disclosure relates to an optical deflection apparatus and an image projection apparatus.

### 2. Description of the Related Art

Conventionally, an image projection apparatus projects an image onto a scan-target surface using an optical deflection apparatus that deflects, at a reflection surface, light emitted from a light emitting unit.

Furthermore, for example, Japanese Patent No. 5492765 discloses an image projection apparatus that includes a first deflector that deflects light into a first direction and a scanning optical system that is disposed between the first deflector and the scan-target surface.

In the configuration of Japanese Patent No. 5492765, in order to reduce TV distortion and trapezoidal distortion of images to be projected, the central axes of the respective optical members constituting the scanning optical system are located on the same straight line to serve as the optical axis of the scanning optical system, and the center of the scan-target surface is shifted in position in a second direction with respect to an intersection between the optical axis and the plane including the scan-target surface. Also, the first deflector is provided such that the axis of the first deflector is inclined with respect to the second direction by a first angle within a plane including the optical axis and the second direction.

### SUMMARY

The present disclosure provides an optical deflection apparatus that includes a first optical deflection part configured to deflect light incident on a first reflection surface, by swinging the first reflection surface about a first swing axis, and a second optical deflection part configured to deflect the light deflected by the first reflection surface, by swinging a second reflection surface about a second swing axis crossing the first swing axis, wherein the first swing axis crosses a first incidence plane including a central axis of the light incident on the first reflection surface and a central axis of the light deflected by the first reflection surface, and the second swing axis crosses a second incidence plane including a central axis of the light incident on the second reflection surface and a central axis of the light deflected by the second reflection surface.

### BRIEF DESCRIPTION OF THE DRAWINGS

FIG. 1 is a perspective view illustrating a configuration example of the entirety of an image projection apparatus according to an embodiment.

FIG. 2A is a plan view illustrating a configuration example of an optical deflection apparatus according to the embodiment.

FIG. 2B is a left side view illustrating the configuration example of the optical deflection apparatus according to the embodiment.

FIG. 2C is a front view illustrating the configuration example of the optical deflection apparatus according to the embodiment.

FIG. 2D is a cross-sectional view taken along line A-A of FIG. 2C.

FIG. 3 is a perspective view illustrating a configuration example of a first optical deflection part according to the embodiment.

FIG. 4A is a drawing for explaining an example of a horizontal driving signal.

FIG. 4B is a drawing for explaining an example of a vertical driving signal.

FIG. 5 is a perspective view illustrating a configuration example of a second optical deflection part according to the embodiment.

FIG. 6A is a drawing illustrating an example of arrangement of the optical deflection apparatus according to the embodiment as seen from a first swing axis direction.

FIG. 6B is a drawing illustrating an example of arrangement of the optical deflection apparatus according to the embodiment as seen from a second swing axis direction.

FIG. 7 is a drawing illustrating an example of incidence of laser light to the optical deflection apparatus according to the embodiment.

FIG. 8 is a drawing illustrating a configuration of an optical deflection apparatus according to a first comparative example.

FIG. 9A is a drawing illustrating an example of incidence of laser light to the optical deflection apparatus according to the first comparative example as seen from the first swing axis direction.

FIG. 9B is a drawing illustrating an example of incidence of laser light to the optical deflection apparatus according to the first comparative example as seen from the second swing axis direction.

FIG. 10 is a perspective view illustrating a configuration of an optical deflection apparatus according to a second comparative example.

FIG. 11 is a drawing illustrating an example of incidence of laser light to the optical deflection apparatus according to the second comparative example.

FIG. 12A is a drawing illustrating an example of distortion according to the first comparative example.

FIG. 12B is a drawing illustrating an example of distortion according to the second comparative example.

FIG. 12C is a drawing illustrating an example of distortion according to the embodiment.

### DESCRIPTION OF THE EMBODIMENTS

Hereinafter, an embodiment will be described with reference to the drawings. In the drawings, the same components are denoted with the same numerals and duplicate descriptions about the same components may be omitted.

The embodiment shown below is an example of an optical deflection apparatus and an image projection apparatus for implementing the technical idea of the present disclosure, and the present disclosure is not limited to the embodiment shown below. Unless otherwise specified, the dimensions, materials, shapes, relative arrangements, and the like of the components described below are not intended to limit the scope of the present disclosure to those described, but are intended to show examples. Furthermore, the sizes and the arrangements of the members shown in the drawings may be exaggerated for the sake of clarification of the explanation.

The optical deflection apparatus according to the embodiment includes a first optical deflection part configured to deflect light incident on a first reflection surface by swinging the first reflection surface about a first swing axis. In addition, the optical deflection apparatus according to the embodiment includes a second optical deflection part configured to deflect light deflected by the first reflection surface by swinging a second reflection surface about a second swing axis that crosses the first swing axis.

For example, such an optical deflection apparatus is used to scan a scan-target surface by deflecting light with an image projection apparatus and the like that projects an image onto the scan-target surface. The image projection apparatus may be, for example, a projector, a welcome projector of a vehicle, a head-up display, a head-mounted display, a headlamp of a vehicle, an object recognition apparatus, a distance measurement apparatus, an ocular fundus camera, or the like.

The welcome projector of the vehicle is a projector provided on a door or the like of the vehicle to project a desired image including a logo when the door is opened. The object recognition apparatus is an apparatus that detects and recognizes a presence or absence of an object or detects and recognizes a distance to an object, on the basis of reflected light or scattered light of projected light reflected or scattered by the object.

With such an image projection apparatus, distortion may occur in the projected image. The distortion refers to a phenomenon in which a projected image is distorted. Types of distortions include a barrel type in which image magnification decreases with distance from the center; a pincushion type distortion in which image magnification increases with distance from the center; a mustache type distortion that is a mixture of both of the barrel type and the pincushion type distortions, i.e., the barrel type distortion occurs close to the center of the image and the distortion gradually turns into the pincushion type distortion towards the periphery of the image; and the like. The term “distortion” as used in the embodiment is meant to include any of the types of distortions described above, and also meant to include a distortion in which the types of distortions described above occur in a mixed manner in a single image.

According to another aspect, the distortion includes: an optical distortion meaning distortion that is corrected by image processing and the like; and TV distortion meaning a distortion that is not corrected by image processing and the like. The term “distortion” as used in the embodiment can be considered to be TV distortion as it is not expected to be corrected by image processing and the like.

In the embodiment, the first swing axis crosses a first incidence plane that includes the central axis of the light that is incident on the first reflection surface and the central axis of the light deflected by the first reflection surface. Further, the second swing axis crosses a second incidence plane that includes the central axis of the light that is incident on the second reflection surface and the central axis of the light that is reflected by the second reflection surface. According to this configuration, in the optical deflection apparatus, the mechanism for reducing distortion of a projected image can be simplified.

In this case, the central axis of the light refers to an axis that passes through the center of a luminous flux that propagates as light. For example, in a case where light is laser light (laser beam), the central axis of the laser light means an axis that passes the center of a cross section of the laser light taken along a plane perpendicular to the propagation direction of the laser light, the axis being along the traveling direction of the laser light.

The term “deflection light” as used in the embodiment means to change the traveling direction of light. In the embodiment, light is deflected by causing the light to be reflected by the reflection surface.

Hereinafter, an embodiment is explained with reference to the image projection apparatus including the optical deflection apparatus according to the embodiment as an example.

In the following drawings, directions may be indicated by the X axis, the Y axis, and the Z axis. The X direction along the X axis indicates a direction in which the first optical deflection part provided in the optical deflection apparatus according to the embodiment deflects and scans light. The Y direction along the Y axis indicates a direction in which the second optical deflection part provided in the optical deflection apparatus according to the embodiment deflects and scans light. The X axis and the Y axis are substantially perpendicular to each other. The Z direction along the Z axis indicates a direction substantially perpendicular to both of the X axis and the Y axis.

A direction indicated by an arrow in the X direction is denoted as +X direction, a direction opposite to +X direction is denoted as −X direction, a direction indicated by an arrow in the Y direction is denoted as +Y direction, a direction opposite to +Y direction is denoted as −Y direction, a direction indicated by an arrow in the Z direction is denoted as +Z direction, and a direction opposite to the +Z direction is denoted as −Z direction. However, the above is not intended to impose limitation on the direction in which the optical deflection apparatus and the image projection apparatus are used, and the optical deflection apparatus and the image projection apparatus may be provided in any desired direction.

<Configuration Example of Image Projection Apparatus 100>

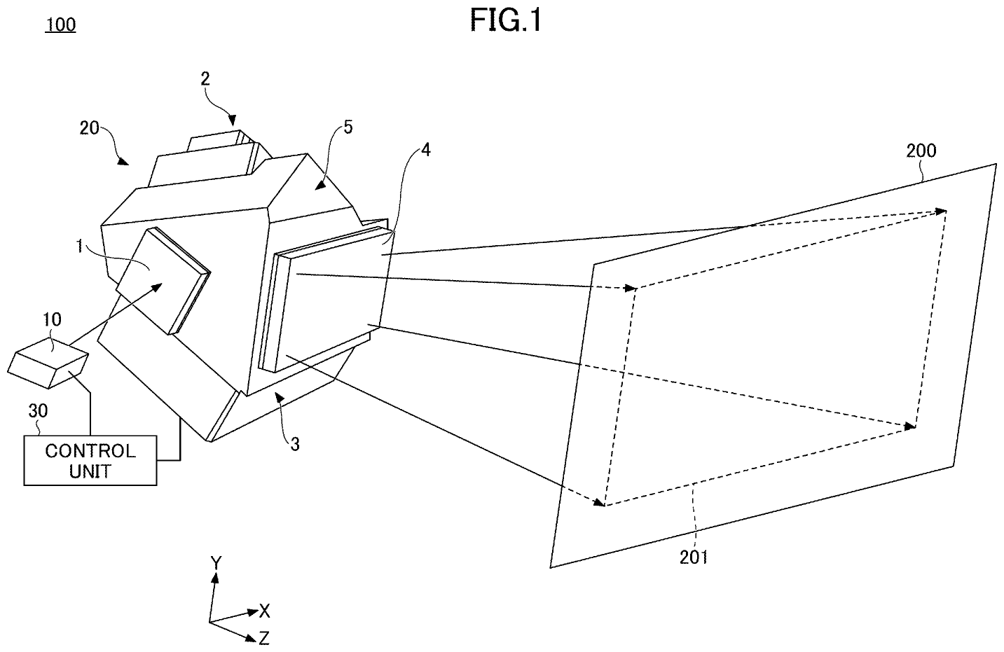

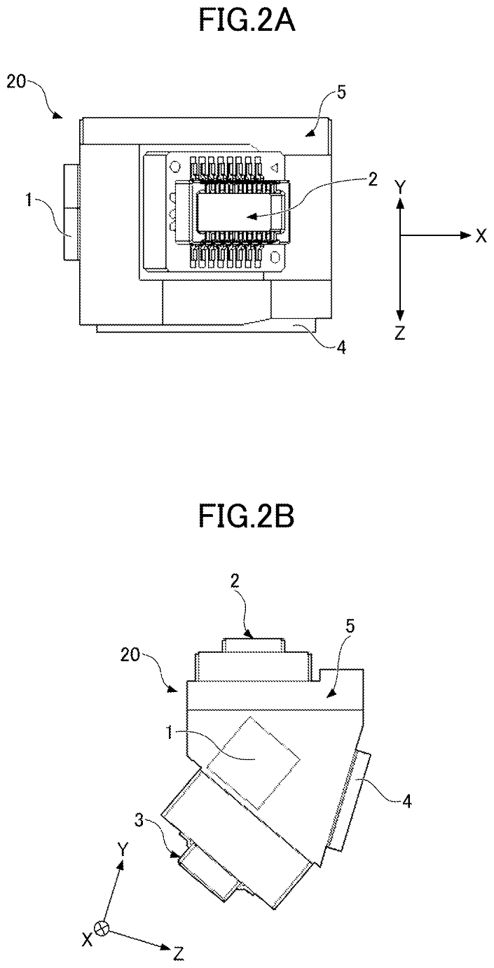

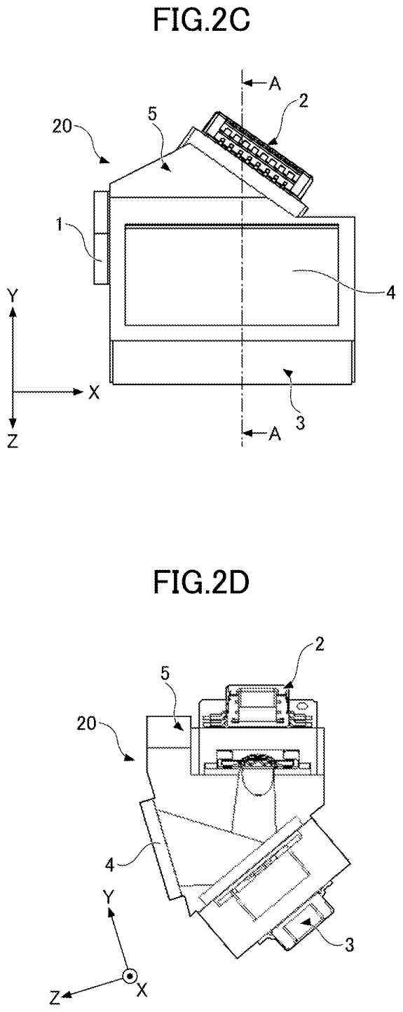

First, a configuration example of the entirety of an image projection apparatus 100 according to the embodiment and the configuration of an optical deflection apparatus 20 provided in the image projection apparatus 100 are explained with reference to FIG. 1 and FIGS. 2A to 2D.

FIG. 1 is a perspective view illustrating the configuration example of the entirety of the image projection apparatus 100 according to an embodiment. FIG. 2A is a plan view illustrating a configuration example of the optical deflection apparatus 20 according to the embodiment. FIG. 2B is a left side view illustrating the configuration example of the optical deflection apparatus 20 according to the embodiment. FIG. 2C is a front view illustrating the configuration example of the optical deflection apparatus 20 according to the embodiment. FIG. 2D is a cross-sectional view taken along line A-A of FIG. 2C.

As illustrated in FIG. 1, the image projection 2C apparatus 100 includes a light emitting unit 10, the optical deflection apparatus 20, and a control unit 30, which are provided in the body of the image projection apparatus 100.

The image projection apparatus 100 causes the optical deflection apparatus 20 to scan, in the X direction and the Y direction, the laser light in respective wavelengths, i.e., red, green, blue, and IR (infrared), emitted by the light emitting unit 10, under the control of the control unit 30 to project an image 201 in full color onto a scan-target surface 200.

In the present embodiment, as an example, the Y direction corresponds to the gravity direction, and the X direction corresponds to a horizontal direction substantially perpendicular to the gravity direction. The optical deflection apparatus 20 deflects laser light of each of the wavelengths of red, green, blue, and IR emitted by the light emitting unit 10 to scan the laser light in two directions, i.e., the X direction and the Y direction, on the scan-target surface 200.

However, the image 201 projected by the image projection apparatus 100 is not limited to images in full color, and may be monochrome images and the like. In a case where a monochrome image is projected, the image projection apparatus 100 scans the monochrome laser light on the scan-target surface 200.

In a case where the image projection apparatus 100 is a projector, the scan-target surface 200 corresponds to a screen and the like. In a case where the image projection apparatus 100 is a head-up display, the scan-target surface 200 corresponds to a front windshield and the like of an automobile.

In a case where the image projection apparatus 100 is a head-mounted display or an ocular fundus camera, the scan-target surface 200 corresponds to a hologram optical element, the retina of an eyeball, and the like. In a case where the image projection apparatus 100 is a headlamp, an object recognition apparatus, or a distance measurement apparatus of a vehicle, the scan-target surface 200 corresponds to a virtual plane in a space.

The light emitting unit 10 includes an LD (Laser Diode) emitting laser light in red, an LD emitting laser light in green, an LD emitting laser light in blue, and an LD emitting laser light in IR. The light emitting unit 10 causes laser light of respective wavelengths, i.e., red, green, blue, and IR, emitted from the LDs of the respective wavelengths, to be incident on the optical deflection apparatus 20. The laser light in respective wavelengths is an example of light emitted by a light emitting unit.

As illustrated in FIG. 1 and FIG. 2, the optical deflection apparatus 20 includes an input window 1, a first optical deflection unit 2, a second optical deflection unit 3, an output window 4, and a housing 5.

The input window 1 is a plate-shaped member that functions as a window through which the laser light emitted by the light emitting unit 10 is input to the inside of the housing 5. The input window 1 is made of materials transparent with respect to the wavelength of laser light in each color emitted by the light emitting unit 10, such as optical glass, heat-resistant glass, hard glass, optical plastic, and hard plastic. It is preferable to provide antireflection films on both sides of the input window 1 to prevent reflection of the laser light.

The first optical deflection unit 2 includes a first optical deflection part 21 and a first package 2a for holding the first optical deflection part 21. The first optical deflection unit 2 deflects the laser light in each color that is input through the input window 1 and causes the deflected laser light to be incident upon the second optical deflection unit 3.

The second optical deflection unit 3 includes a second optical deflection part 31 and a second package 3a for holding the second optical deflection part. The second optical deflection unit 3 further deflects the laser light in each color deflected by the first optical deflection unit 2, and scans the laser light on the scan-target surface 200 in each direction, i.e., the X direction and the Y direction.

The first package 2a and the second package 3a are configured to include: alumina ceramic; a metal material such as aluminum, aluminum alloy, or stainless steel; or a plastic material. Further, the first package 2a and the second package 3a include a circuit board and the like constituted by fiber reinforced plastics (FRP), flexible printed circuits (FPC), or the like.

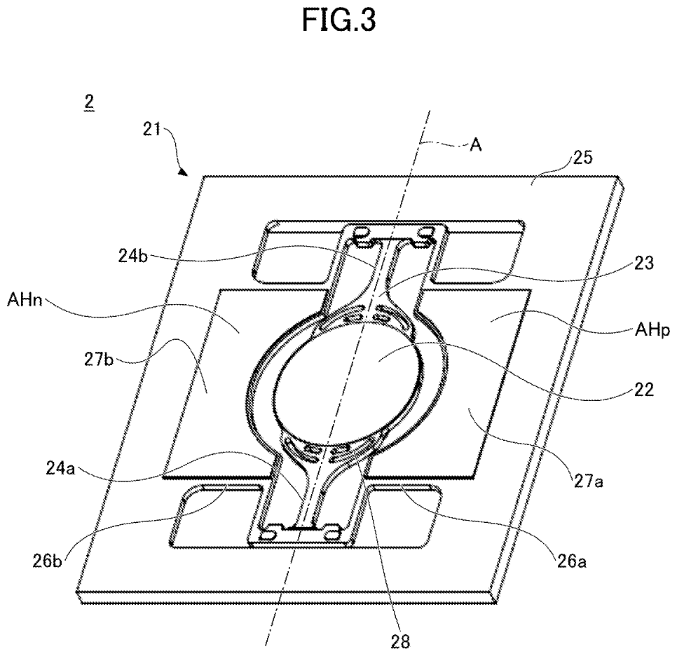

Each configuration of the first optical deflection unit 2 and the second optical deflection unit 3 is explained later with reference to FIG. 3 to FIG. 6 and the like.

The output window 4 is a plate-shaped member that functions as a window through which the laser light deflected by the first optical deflection unit 2 and thereafter further deflected by the second optical deflection unit 3 is output from the inside of the housing 5. The output window 4 is made of materials transparent with respect to the wavelength of laser light in each color emitted by the light emitting unit 10, such as optical glass, heat-resistant glass, hard glass, optical plastic, and hard plastic. It is preferable to provide antireflection films on both sides of the output window 4 to prevent reflection of the laser light.

The housing 5 is a member that fixes and holds each of the input window 1, the first optical deflection unit 2, the second optical deflection unit 3, and the output window 4. In addition, the housing 5 has a function of preventing dust, debris, or the like from adhering to the first optical deflection unit 2 or the second optical deflection unit 3 by preventing dust, debris, or the like from entering the inside.

The material of the housing 5 is not particularly limited, but may be configured to include: alumina ceramic; a metal material such as aluminum, aluminum alloy, or stainless steel; or a plastic material.

For example, the housing 5 is preferably configured to include an opaque material that is not transparent with respect to the wavelength of visible light, because external light such as indoor lighting and sunlight is prevented from being incident on the inside of the housing 5, and furthermore, the laser light emitted by the light emitting unit 10 is prevented from leaking to the outside of the housing 5.

The control unit 30 controls the light emission of the LD of each color achieved by the light emitting unit 10 by applying a driving signal such as a driving voltage to the light emitting unit 10. The control unit 30 controls the scanning of the laser light achieved by the optical deflection apparatus 20 by applying a driving signal such as a driving voltage to the optical deflection apparatus 20.

Some of the functions of the control unit 30 may be achieved by an electric circuit, and some other of the functions may be achieved by software that is executable by a central processing unit (CPU).

<Configuration Example of First Optical Deflection Part 21>

Next, the configuration of the first optical deflection part 21 is explained with reference to FIG. 3. FIG. 3 is a perspective view for explaining an example of the configuration of the first optical deflection part 21. For the sake of explanation, FIG. 3 illustrates the first optical deflection part 21 with the first package 2a of the first optical deflection unit 2 being detached.

The first optical deflection part 21 deflects the laser light incident on the first reflection surface 22 by swinging the first reflection surface 22 about the first swing axis A. The first optical deflection part 21 is, for example, a MEMS (Micro Electro Mechanical Systems) mirror or the like that drives the first reflection surface 22 by a piezoelectric element.

As illustrated in FIG. 3, the first optical deflection part 21 includes a first reflection surface 22, a first movable portion 23, torsional beams 24a and 24b, a first support portion 25, first driving beams 26a and 26b, and first drive sources 27a and 27b.

The first reflection surface 22 is a surface that reflects light. The first reflection surface 22 has a substantially circular outer shape and is supported on the upper surface of the first movable portion 23. The first reflection surface 22 may be a surface formed on the upper surface of the first movable portion 23.

Both ends of the first movable portion 23 are connected to the ends of torsional beams 24a and 24b. The torsional beams 24a and 24b constitute the first swing axis A, extending along the direction of the first swing axis A and supporting the first movable portion 23 from both sides in the direction of the first swing axis A.

When the torsional beams 24a and 24b are twisted, the first reflection surface 22 supported by the first movable portion 23 swings about the first swing axis A. When the first reflection surface 22 is twisted, laser light that is incident on and reflected by the first reflection surface 22 can be deflected and scanned about the first swing axis A. The torsional beams 24a and 24b are connected by and supported on the first support portion 25.

In the first movable portion 23, slits 28 are formed along the circumference of the first reflection surface 22. With the slits 28, while the stress concentration generated by the torsional motion of the torsional beams 24a and 24b can be dispersed to prevent damage to the first reflection surface 22, the torsion caused by the torsional beams 24a and 24b can be transmitted to the first reflection surface 22.

The first driving beams 26a and 26b constitute a pair and are provided such that the first reflection surface 22 and the first movable portion 23 are interposed between the first driving beams 26a and 26b in the direction perpendicular to the torsional beams 24a and 24b. The first drive source 27a is formed on the upper surface of the first driving beam 26a, and the first drive source 27b is formed on the upper surface of the first driving beam 26b.

The first drive source 27a includes: an upper electrode formed in a thin film of a piezoelectric element (hereinafter also referred to as a “piezoelectric thin film”) on the upper surface of the first driving beam 26a; and a lower electrode formed in a piezoelectric thin film on the lower surface of the first driving beam 26a. The first drive source 27a expands and contracts depending on the polarity of the driving voltage applied to the upper and lower electrodes.

Likewise, the first drive source 27b includes: an upper electrode formed in a piezoelectric thin film on the upper surface of the first driving beam 26b; and a lower electrode formed in a piezoelectric thin film on the lower surface of the first driving beam 26b. The first drive source 27b contracts, or expands and contracts depending on the polarity of the driving voltage applied to the upper and lower electrodes.

When voltages of different phases are applied alternately to the first driving beam 26a and the first driving beam 26b, the first driving beam 26a and the first driving beam 26b alternately vibrate, on the left side and the right side of the first reflection surface 22, to the opposite sides in the vertical direction. Accordingly, the first reflection surface 22 can swing about the first swing axis A, which includes the torsional beams 24a and 24b. For example, resonant vibration is used to swing the first driving beams 26a and 26b, so that the first reflection surface 22 can swing at a high speed.

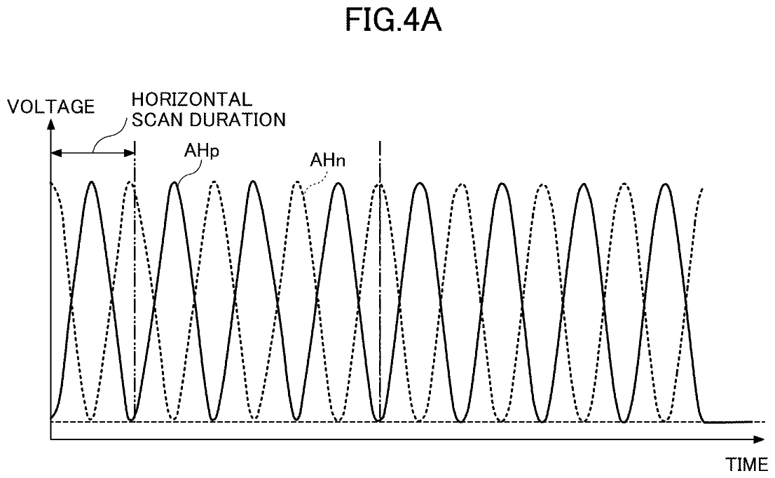

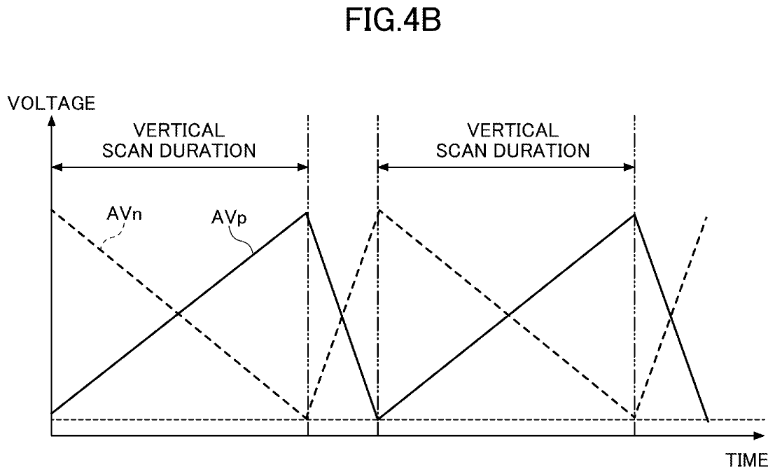

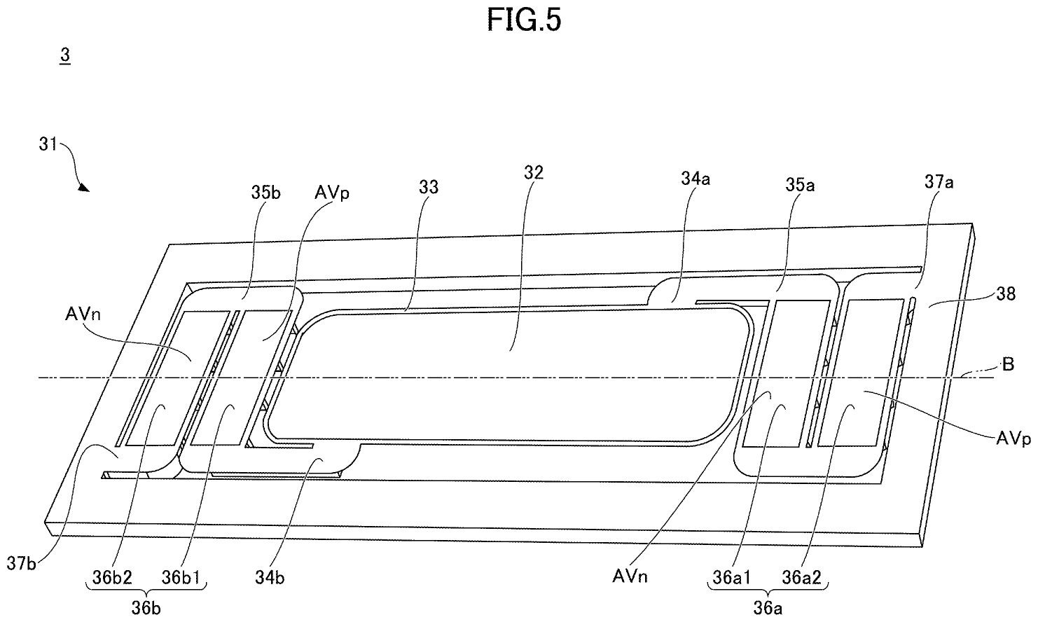

In this case, FIG. 4A is a drawing for explaining an example of a horizontal driving signal. FIG. 4B is a drawing for explaining an example of a vertical driving signal.

As illustrated in FIGS. 4A and 4B, both of the horizontal driving signal AHp and a horizontal driving signal AHn are sine waves with the same cycle and amplitude, and a horizontal driving signal AHn is shifted by half the cycle with respect to the horizontal driving signal AHp. Specifically, the horizontal driving signals AHp and AHn are in such a relationship that the potentials of the horizontal driving signals AHp and AHn are inverted with respect to the intermediate potential. The first reflection surface 22 is driven according to a potential difference between the horizontal driving signal AHp and the horizontal driving signal AHn, and the swing angle of the first reflection surface 22 corresponds to the amplitude of the horizontal driving signal AHp and the horizontal driving signal AHn.

The first optical deflection part 21 can be produced by, for example, a semiconductor process using a SOI (Silicon On Insulator) substrate including a support layer, a BOX (Buried Oxide) layer, and an active layer.

<Configuration Example of Second Optical Deflection Part 31>

Next, the configuration of the second optical deflection part 31 is explained with reference to FIG. 5. FIG. 5 is a perspective view illustrating a configuration example of the second optical deflection part 31. For the sake of explanation, FIG. 5 illustrates the second optical deflection part 31 with the second package of the second optical deflection unit 3 being detached.

The second optical deflection part 31 deflects the laser light deflected by the first reflection surface 22 by swinging a second reflection surface 32 about a second swing axis B crossing the first swing axis A. The second optical deflection part 31 is, for example, a MEMS mirror or the like that drives the second reflection surface 32 by a piezoelectric element.

As illustrated in FIG. 5, the second optical deflection part 31 includes a second reflection surface 32, a second movable portion 33, first connection portions 34a and 34b, second driving beams 35a and 35b, second drive sources 36a and 36b, second connection portions 37a and 37b, and a second support portion 38.

The second reflection surface 32 is a surface that reflects light. The second reflection surface 32 has a substantially circular outer shape and is supported on the upper surface of the second movable portion 33. The second reflection surface 32 may be a surface formed on the second movable portion 33.

The second movable portion 33 is connected via the first connection portion 34a to one end of the second driving beam 35a. The second driving beam 35a includes: multiple vertical beams in a rectangular shape extending in a direction perpendicular to the second swing axis B; and a folded portion for connecting the ends of adjacent vertical beams with each other, and has a zigzag shape as a whole. The other end of the second driving beam 35a is connected to and supported by the second support portion 38 via the second connection portion 37a.

Also, the second movable portion 33 is connected via the first connection portion 34b to one end of the second driving beam 35b. The second driving beam 35b includes: multiple vertical beams in a rectangular shape extending in the direction perpendicular to the second swing axis B; and a folded portion for connecting the ends of adjacent vertical beams with each other, and has a zigzag shape as a whole. The other end of the second driving beam 35b is connected to and supported by the second support portion 38 via the second connection portion 37b.

For each of the vertical beams each of which is a rectangular unit not including a curved portion, the second drive source 36a is formed on the upper surface of the second driving beam 35a. The second drive source 36a includes: an upper electrode formed in a piezoelectric thin film on the upper surface of the second driving beam 35a; and a lower electrode formed in a piezoelectric thin film on the lower surface of the second driving beam 35a.

For each of the vertical beams that are rectangular units not including curved portions, the second drive source 36b is formed on the upper surface of the second driving beam 35b. The second drive source 36b includes: upper electrodes formed in a piezoelectric thin film on the upper surface of the second driving beam 35b; and lower electrodes formed in a piezoelectric thin film on the lower surface of the second driving beam 35b.

By applying a driving voltage to the vertical beams adjacent to each other of the second drive sources 36a and 36b, the second driving beams 35a and 35b bend all the vertical beams in an upward direction to transmit the accumulation of bending of each vertical beam to the second movable portion 33. According to this operation, the second driving beams 35a and 35b swing the second reflection surface 32 about the second swing axis B. For example, non-resonant vibration can be used to drive the second driving beams 35a and 35b to swing. In the present embodiment, although, for example, resonant driving is used for the first optical deflection part 21 and non-resonant driving is used for the second optical deflection part 31, resonant driving may be used for both of the first optical deflection part 21 and the second optical deflection part 31. Alternatively, non-resonant driving may be used for both of the first optical deflection part 21 and the second optical deflection part 31.

For example, the second drive source 36a includes second drive sources 36a1 and 36a2 arranged in a direction away from the second movable portion 33. Also, the second drive source 36b includes second drive sources 36b1 and 36b2 arranged in a direction away from the second movable portion 33.

In this case, the same sawtooth-shaped waveforms are applied to the second drive sources 36a1 and 36b2 and right-and-left inverted sawtooth-shaped waveforms are applied to the second drive sources 36a2 and 36b1, so that the second movable portion 33 swings about the second swing axis B. The second optical deflection part 31 as illustrated in FIG. 5 has a point symmetrical structure, but in a case where the second optical deflection part 31 has a line symmetrical structure, the second drive sources 36a1, 36b1, 36a2, and 36b2 are driven by applying right-and-left inverted sawtooth-shaped waveforms to the second drive sources 36a1, 36b1, 36a2, and 36b2.

The second reflection surface 32 is connected to the second driving beams 35a and 35b via the first connection portions 34a and 34b arranged at point symmetrical positions, and therefore, the vertical driving signals are applied as shown in the relationship of FIG. 4B. The vertical beams bend only in the upward direction, not bending in the opposite directions, i.e., upward and downward directions. The driving signals applied to the piezoelectric thin films are similar to FIG. 4B.

Both of vertical driving signals AVp and AVn are sawtooth-shaped waveforms having the same cycle and amplitude, and the vertical driving signals AVp and AVn have potentials that are inverted with respect to the intermediate potential. The second reflection surface 32 is driven according to the potential difference between the vertical driving signals AVp and AVn, and the swing angle of the second reflection surface 32 corresponds to the amplitude of the vertical driving signals AVp and AVn.

The driving wires for applying driving voltages to the upper electrodes and the lower electrodes of the second drive sources 36a and 36b are connected to predetermined terminals included in a terminal group provided in the second support portion 38.

Like the first optical deflection part 21, the second optical deflection part 31 can be produced by, for example, a semiconductor process using a SOI (Silicon On Insulator) substrate including a support layer, a BOX (Buried Oxide) layer, and an active layer.

<Example of Arrangement of Optical Deflection Apparatus 20>

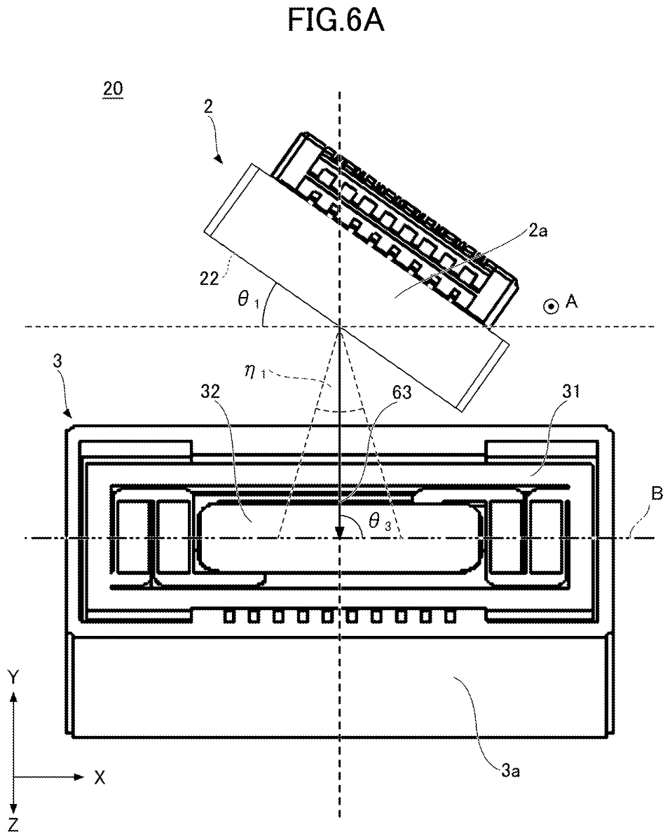

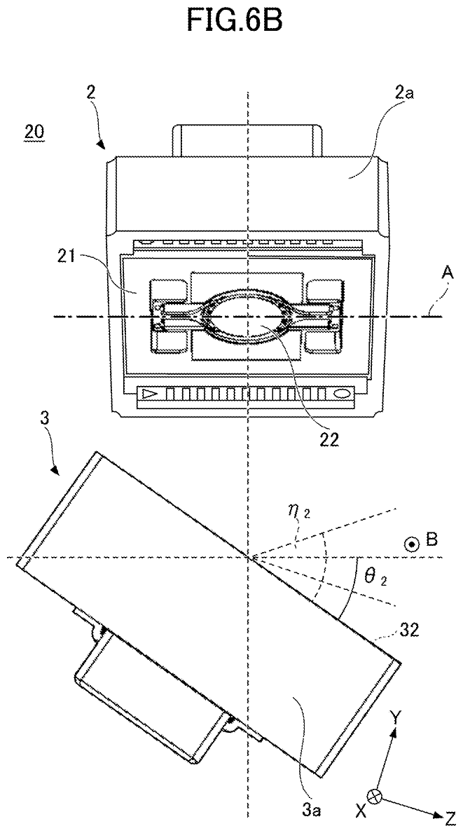

Next, an arrangement of the optical deflection apparatus 20 is explained with reference to FIGS. 6A and 6B. FIGS. 6A and 6B are drawings illustrating an example of arrangement of the optical deflection apparatus 20. For the sake of explanation, FIGS. 6A and 6B illustrate the first optical deflection unit 2 and the second optical deflection unit 3 with the housing 5 and the like of the optical deflection apparatus 20 being detached.

FIG. 6A is a drawing illustrating the first optical deflection unit 2 and the second optical deflection unit 3 as seen from the right side in the first swing axis A. The direction in which FIG. 6A is depicted is the same as the direction in which FIG. 2C is depicted. FIG. 6B is a drawing illustrating the first optical deflection unit 2 and the second optical deflection unit 3 as seen from the right side in the second swing axis B. The direction in which FIG. 6B is depicted is the same as the direction in which FIG. 2B is depicted.

As illustrated in FIG. 6, the first optical deflection unit 2 includes the first optical deflection part 21 and the first package 2a. The second optical deflection unit 3 includes a second optical deflection part 31 and a second package 3a.

The second optical deflection unit 3 is arranged so that the second swing axis B of the second optical deflection part 31 is along the X axis. The first optical deflection unit 2 is arranged so that the first swing axis A of the first optical deflection part 21 is substantially perpendicular to the second swing axis B.

The first optical deflection part 21 is arranged so that the laser light that is incident on the first reflection surface 22 can be deflected by swinging the first reflection surface 22 about the first swing axis A, so that the second reflection surface 32 is scanned with the deflected laser light along the second swing axis B.

As illustrated in FIG. 6A, an inclination of the second swing axis B with respect to the first reflection surface 22 that is not swinging is an angle θ₁. This angle θ₁ is preferably 30 degrees. However, it is tolerated that the angle θ₁ has a margin of 9.0 degrees, which is 1/10 of 90 degrees, i.e., a variation of ±4.5 degrees, in view of a variation in manufacture and the like. Therefore, the angle θ₁ is preferably 25.5 degrees or more and 34.5 degrees or less.

A scan angle range η₁ indicated by broken lines of FIG. 6A indicates a scan angle range of the center of the intensity of laser light scanned by the first optical deflection part 21. Scan center laser light 63 passing through the center of the scan angle range η₁ is incident upon the second reflection surface 32 from a direction substantially perpendicular to the second swing axis B. Specifically, an angle θ₃ formed by the scan center laser light 63 and the second swing axis B is approximately 90 degrees.

As illustrated in FIG. 6B, an inclination of the first swing axis A with respect to the second reflection surface 32 that is not swinging is an angle θ₂. This angle θ₂ is preferably 35 degrees. However, it is tolerated that the angle θ₂ has a variation of ±4.5 degrees in view of a variation in manufacture and the like. The angle θ₂ is preferably 30.5 degrees or more and 39.5 degrees or less.

A scan angle range η₂ indicated by broken lines of FIG. 6B indicates a scan angle range of the center of the intensity of laser light scanned by the second optical deflection part 31.

<Incidence Example of Laser Light of Optical Deflection Apparatus 20>

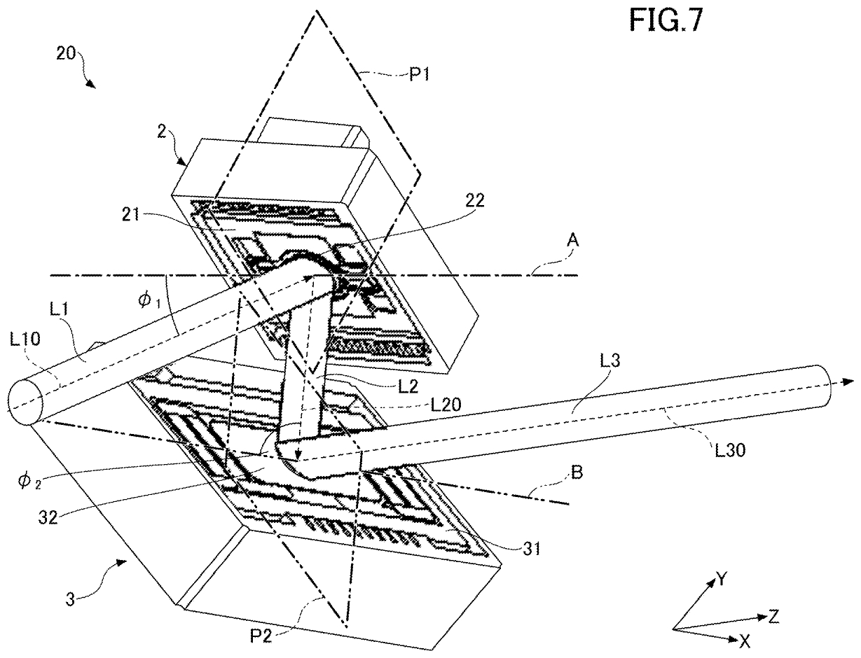

Next, incidence of laser light to the optical deflection apparatus 20 is explained with reference to FIG. 7. FIG. 7 is a perspective view for explaining an example of incidence of laser light to the optical deflection apparatus 20.

FIG. 7 illustrates laser light that is incident on and deflected by each of the first optical deflection unit 2 and the second optical deflection unit 3, with the housing 5 and the like of the optical deflection apparatus 20 being detached.

Only one of the laser lights of Red, Green, Blue, and IR is shown as the laser light that is incident on and deflected by each of the first optical deflection unit 2 and the second optical deflection unit 3. The first optical deflection unit 2 and the second optical deflection unit 3 perform the same operation for the laser light of any wavelength.

As illustrated in FIG. 7, incident laser light L1 is laser light that is incident on the first reflection surface 22 of the first optical deflection part 21 of the first optical deflection unit 2. An incidence central axis L10 indicated by a broken line arrow is the central axis of the incident laser light L1. The incident laser light L1 propagates in the direction indicated by the arrow of the incidence central axis L10 and is incident on the first reflection surface 22. Thereafter, the incident laser light L1 is reflected by the first reflection surface 22 toward the second reflection surface 32 of the second optical deflection part 31 of the second optical deflection unit 3.

Reflected laser light L2 is laser light that is reflected by the first reflection surface 22 and is incident on the second reflection surface 32. A reflection central axis L20 indicated by a broken line arrow is the central axis of the reflected laser light L2. In a case where the first reflection surface 22 and the second reflection surface 32 are not swinging, the reflected laser light L2 propagates in the direction indicated by the arrow of the reflection central axis L20 and is incident on the second reflection surface 32. Thereafter, the reflected laser light L2 is reflected by the second reflection surface 32.

Output laser light L3 is laser light that is reflected by the second reflection surface 32 and is output from the inside to the outside of the optical deflection apparatus 20. An output central axis L30 indicated by a broken line arrow is the central axis of the output laser light L3. In a case where the first reflection surface 22 and the second reflection surface 32 are not swinging, the output laser light L3 propagates in the direction indicated by the arrow of the output central axis L30, and is output from the optical deflection apparatus 20.

The first optical deflection part 21 deflects the incident laser light L1 by swinging the first reflection surface 22 about the first swing axis A. The reflected laser light L2 reflected and deflected by the first reflection surface 22 is scanned along the second swing axis B on the second reflection surface 32.

The second optical deflection part 31 deflects the reflected laser light L2 by swinging the second reflection surface 32 about the second swing axis B. The output laser light L3 reflected and deflected by the second reflection surface 32 is output from the optical deflection apparatus 20, and is scanned along each of the X direction and the Y direction on the scan-target surface 200 (see FIG. 1).

In this case, a first incidence plane P1 indicated by a parallelogram of a long dashed short dashed line in FIG. 7 is a plane including the incidence central axis L10 of the incident laser light L1 and the reflection central axis L20 of the reflected laser light L2. In the present embodiment, the first swing axis A is configured to be substantially perpendicular to the first incidence plane P1. In other words, an angle ϕ₁ formed between the first swing axis A and the first incidence plane P1 is configured to be approximately 90 degrees. Being “substantially perpendicular” is an example of “crossing”.

Also, a second incidence plane P2 indicated by a parallelogram of a long dashed short dashed line in FIG. 7 is a plane including the reflection central axis L20 of the reflected laser light L2 and the output central axis L30 of the output laser light L3. In the present embodiment, the second swing axis B is configured to be substantially perpendicular to the second incidence plane P2. In other words, an angle ϕ₂ formed between the second swing axis B and the second incidence plane P2 is configured to be approximately 90 degrees.

A direction in which the reflected laser light L2 is incident on the second reflection surface 32 changes according to the scanning with the first optical deflection part 21, and accordingly, the direction of the second incidence plane P2 changes. Therefore, the second swing axis B and the second incidence plane P2 may be shifted from the perpendicular state.

In contrast, in the present embodiment, the scan center laser light 63 passing through the center of the scan angle range η₁ of scanning performed by the first optical deflection part 21 is incident on the second reflection surface 32 from the direction substantially perpendicular to the second swing axis B (see FIG. 6). Therefore, even in a case where the reflected laser light L2 is scanned by the first optical deflection part 21, the second incidence plane P2, formed by the scanned reflected laser light L2, and the second swing axis B are brought closer to such a state that the second incidence plane P2 and the second swing axis B are perpendicular to each other.

<Operations of Optical Deflection Apparatus 20>

Next, operations of the optical deflection apparatus 20 are explained. First, before the explanation about the operations, the configuration and arrangement of each of an optical deflection apparatus 20a according to the first comparative example and an optical deflection apparatus 20b according to the second comparative example are explained.

(Configuration and Arrangement of Optical Deflection Apparatus 20a According to First Comparative Example)

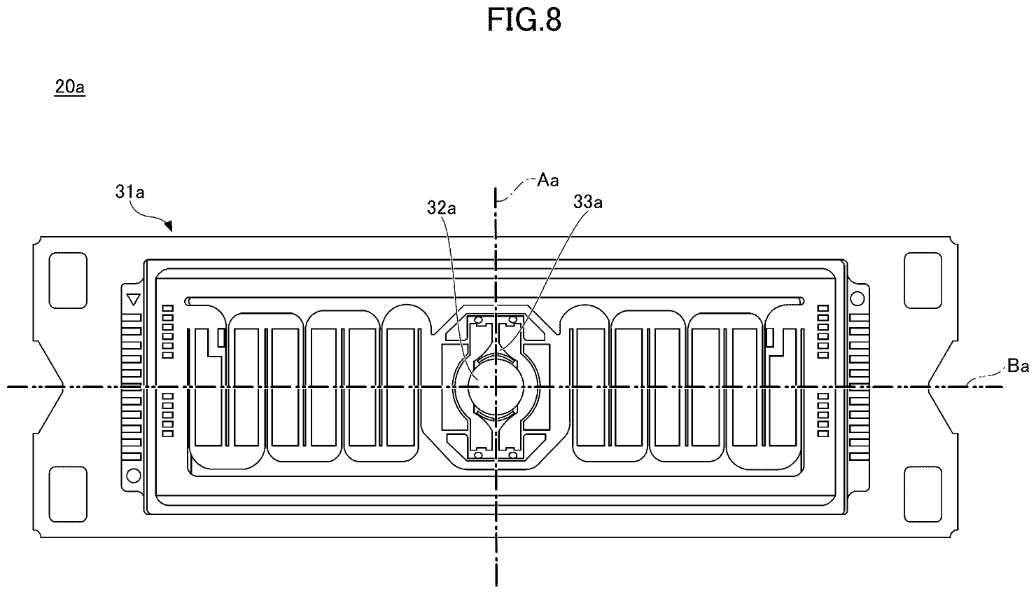

FIG. 8 is a drawing illustrating a configuration of an optical deflection part 31a of the optical deflection apparatus 20a according to the first comparative example. The optical deflection apparatus 20a scans laser light in two directions using the single optical deflection part 31a.

In FIG. 8, the optical deflection part 31a swings a reflection surface 32a about both of a first swing axis Aa and a second swing axis Ba, so that the laser light reflected by the reflection surface 32a is deflected and scanned in two directions, i.e., about the first swing axis Aa and about the second swing axis Ba. The optical deflection part 31a is, for example, a MEMS mirror or the like that drives the reflection surface 32a by a piezoelectric element.

The configuration of the optical deflection part 31a is equivalent to a configuration in which the first optical deflection part 21 as illustrated in FIG. 3 is provided instead of the second movable portion 33 of the second optical deflection part 31 as illustrated in FIG. 5, and the second driving beams 35a and 35b are connected to the first support portion 25. Therefore, in the following explanation, redundant explanation about the configuration of the optical deflection part 31a is omitted.

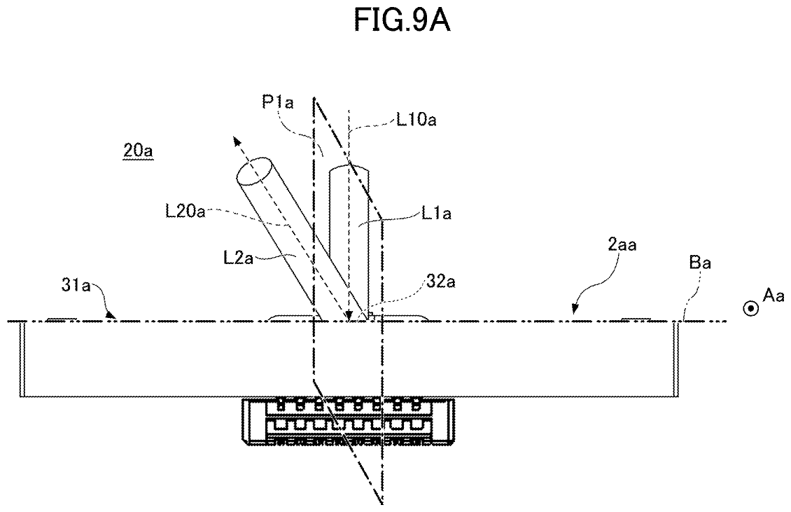

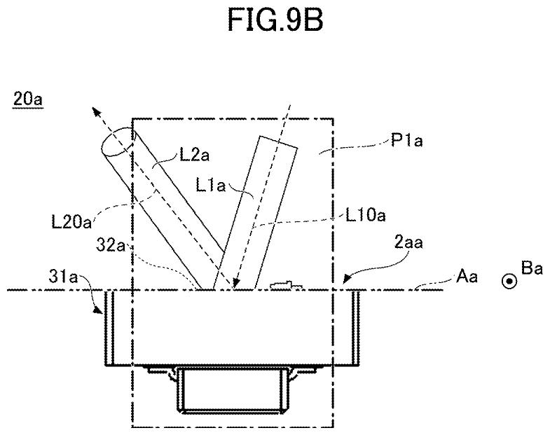

FIG. 9A is a drawing illustrating an example of incidence of laser light to the optical deflection apparatus 20a as seen from the direction of the first swing axis A. FIG. 9B is a drawing illustrating an example of incidence of laser light to the optical deflection apparatus 20b as seen from the direction of the second swing axis B.

As illustrated in FIG. 9, the optical deflection part 31a is held on a package 2aa. Incident laser light L1a is laser light that is incident on the reflection surface 32a of the optical deflection part 31a. An incidence central axis L10a indicated by a broken line arrow is the central axis of the incident laser light L1a. The incident laser light L1a propagates in the direction indicated by the arrow of the incidence central axis L10a and is incident on the reflection surface 32a. Thereafter, the incident laser light L1a is reflected by the reflection surface 32a.

The reflected laser light L2 is laser light that is reflected by the reflection surface 32a and is output from the inside to the outside of the optical deflection apparatus 20a. A reflection central axis L20a indicated by a broken line arrow is the central axis of reflected laser light L2a. The reflected laser light L2a propagates in the direction indicated by the arrow of the reflection central axis L20a, and is output from the optical deflection apparatus 20a.

The optical deflection part 31a deflects the incident laser light L1a by swinging the reflection surface 32a about the first swing axis Aa. Also, the optical deflection part 31a deflects the incident laser light L1a by swinging the reflection surface 32a about the second swing axis Ba. The reflected laser light L2a reflected and deflected by the reflection surface 32a is output from the optical deflection apparatus 20a, and, for example, the reflected laser light L2a is scanned in each of the X direction and the Y direction on the scan-target surface 200 (see FIG. 1).

In this case, an incidence plane P1a indicated by a parallelogram of a long dashed short dashed line in FIG. 9 is a plane including the incidence central axis L10a of the incident laser light L1a and the reflection central axis L20a of the reflected laser light L2a. In the first comparative example, the first swing axis Aa is configured to be substantially parallel to the incidence plane P1a.

In this manner, the optical deflection apparatus 20a is different from the optical deflection apparatus 20 according to the embodiment in that laser light is scanned in two directions by the single optical deflection part 31a. Also, the optical deflection apparatus 20a is different from the optical deflection apparatus 20 in that the first swing axis Aa is configured to be substantially parallel to the incidence plane P1a.

(Configuration and Arrangement of Optical Deflection Apparatus 20a According to Second Comparative Example)

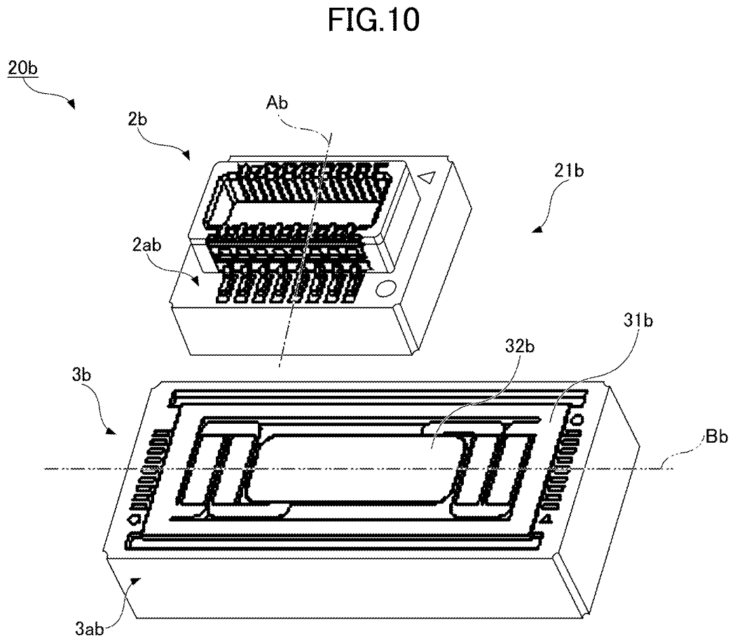

Next, FIG. 10 is a perspective view for explaining the optical deflection apparatus 20b according to the second comparative example. The optical deflection apparatus 20b scans laser light in two directions by using a first optical deflection unit 2b and a second optical deflection unit 3b.

As illustrated in FIG. 10, the first optical deflection unit 2b includes a first optical deflection part 21b and a first package 2ab for holding the first optical deflection part 21b.

The first optical deflection part 21b swings a first reflection surface 22b about a first swing axis Ab, so that the laser light deflected by the first reflection surface 22b is deflected about the first swing axis Ab. The first optical deflection part 21b is, for example, a MEMS mirror or the like that drives the first reflection surface 22b by a piezoelectric element.

Also, as illustrated in FIG. 10, the second optical deflection unit 3b includes a second optical deflection part 31b and a second package 3ab for holding the second optical deflection part 31b.

The second optical deflection part 31b swings a second reflection surface 32b about a second swing axis Bb, so that the laser light deflected by the second reflection surface 32b is deflected about the second swing axis Bb. The second optical deflection part 31b is, for example, a MEMS mirror or the like that drives the second reflection surface 32b by a piezoelectric element.

The configuration of the first optical deflection unit 2b is equivalent to the first optical deflection unit 2, and the configuration of the second optical deflection unit 3b is equivalent to the second optical deflection unit 3. Therefore, in this case, redundant explanation about the configuration of the first optical deflection unit 2b and the second optical deflection unit 3b is omitted.

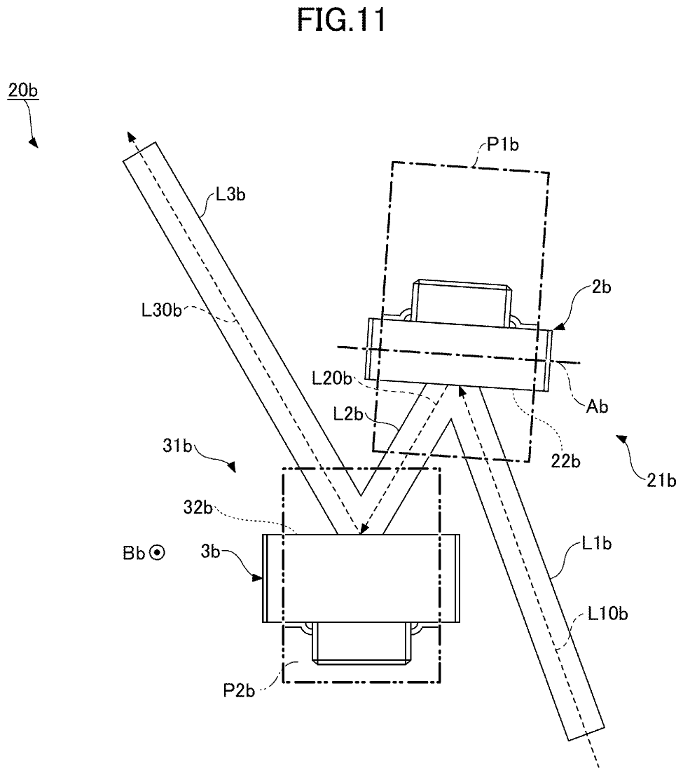

Next, FIG. 11 is a drawing illustrating an example of incidence of laser light to the optical deflection apparatus 20b.

As illustrated in FIG. 11, incident laser light L1b is laser light incident on the first reflection surface 22b of the first optical deflection part 21b of the first optical deflection unit 2b. An incidence central axis L10b indicated by a broken line arrow is the central axis of the incident laser light L1b. The incident laser light L1b propagates in the direction indicated by the arrow of the incidence central axis L10b and is incident on the first reflection surface 22b. Thereafter, the incident laser light L1b is reflected by the first reflection surface 22b toward the second reflection surface 32b of the second optical deflection part 31b of the second optical deflection unit 3b.

Reflected laser light L2b is laser light that is reflected by the first reflection surface 22b and is incident on the second reflection surface 32b. A reflection central axis L20b indicated by a broken line arrow is the central axis of the reflected laser light L2b. The reflected laser light L2b propagates in the direction indicated by the arrow of the reflection central axis L20b and is incident on the second reflection surface 32b. Thereafter, the reflected laser light L2b is reflected by the second reflection surface 32b.

Output laser light L3b is laser light that is reflected by the second reflection surface 32b and is output from the inside to the outside of the optical deflection apparatus 20b. An output central axis L30b indicated by a broken line arrow is the central axis of the output laser light L3b. The output laser light L3b propagates in the direction indicated by the arrow of the output central axis L30b, and is output from the optical deflection apparatus 20b.

The first optical deflection part 21b deflects the incident laser light L1b by swinging the first reflection surface 22b about the first swing axis Ab. The reflected laser light L2b reflected and deflected by the first reflection surface 22b is scanned in a direction along the second swing axis Bb on the second reflection surface 32b.

The second optical deflection part 31b deflects the reflected laser light L2b by swinging the second reflection surface 32b about the second swing axis Bb. The output laser light L3b reflected and deflected by the second reflection surface 32b is output from the optical deflection apparatus 20b, and, for example, the output laser light L3b is scanned in each of the X direction and the Y direction on the scan-target surface 200 (see FIG. 1).

In this case, a first incidence plane P1b indicated by a rectangle of a long dashed short dashed line in FIG. 11 is a plane including the incidence central axis L10b of the incident laser light L1b and the reflection central axis L20b of the reflected laser light L2b. In the second comparative example, the first swing axis Ab is configured to be substantially parallel to the first incidence plane P1b.

A second incidence plane P2b indicated by a rectangle of a long dashed double-short dashed line in FIG. 11 is a plane including the reflection central axis L20b of the reflected laser light L2b and the output central axis L30b of the output laser light L3b. In the second comparative example, the second swing axis Bb is configured to be substantially perpendicular to the second incidence plane P2b.

In this manner, the optical deflection apparatus 20b is different from the optical deflection apparatus 20 according to the embodiment in the arrangement of the first optical deflection unit 2b and the second optical deflection unit 3b. Furthermore, the optical deflection apparatus 20b is different from the optical deflection apparatus 20 in that the first swing axis Ab is configured to be substantially parallel to the first incidence plane P1b.

### Example of Distortion

Next, distortions that occur when the image projection apparatus 100 uses the optical deflection apparatuses according to the first and second comparative examples and the present embodiment are explained.

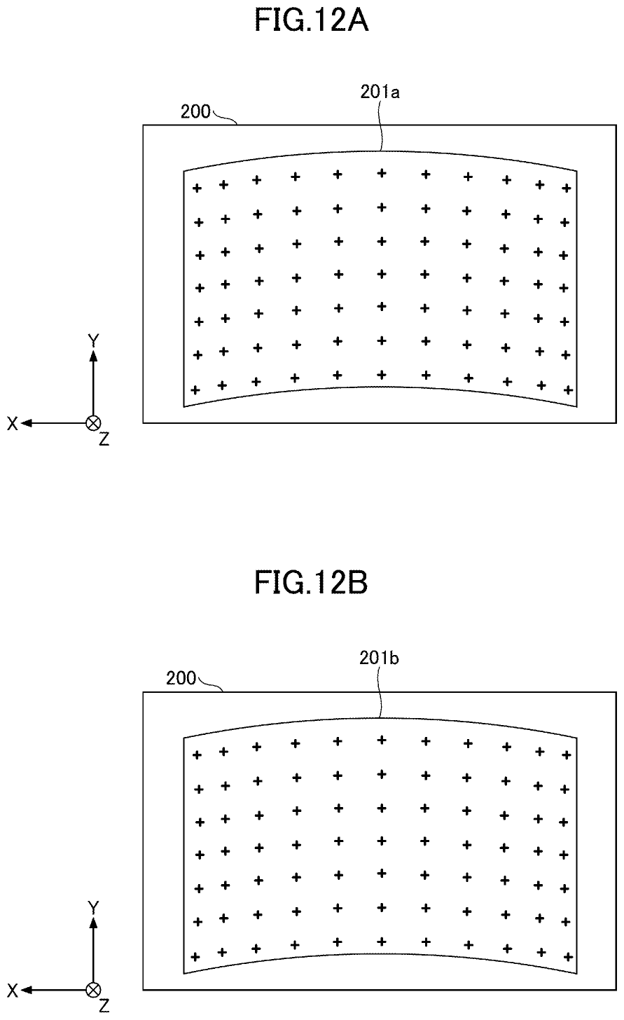

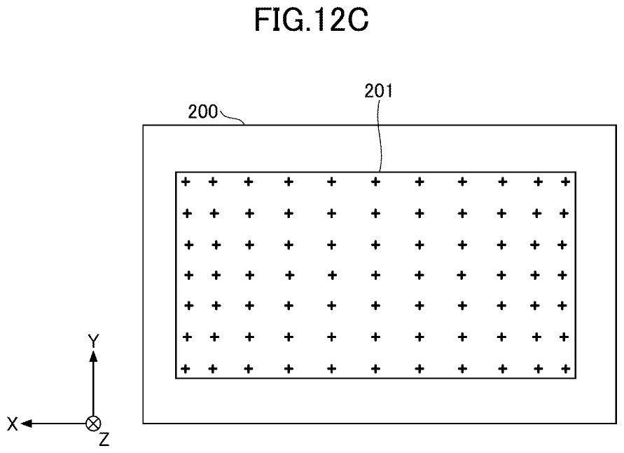

FIG. 12A is a drawing illustrating an example of distortion that occurs when the optical deflection apparatus 20a according to the first comparative example is used. FIG. 12B is a drawing illustrating an example of distortion that occurs when the optical deflection apparatus 20b according to the second comparative example is used. FIG. 12C is a drawing illustrating an example of distortion that occurs when the optical deflection apparatus 20 according to the present embodiment is used.

In an image 201a generated with the optical deflection apparatus 20a As illustrated in FIG. 12A, toward the center in the X direction, the end portion at +Y side expands to +Y side, and the end portion at −Y side shrinks to +Y side. Distortion including both of the barrel type and the pincushion type in a mixed manner occurs significantly.

In the optical deflection apparatus 20a, the first swing axis Aa is configured to be substantially parallel to the incidence plane P1a (see FIG. 9). Therefore, scanning performed by the optical deflection part 31a is likely to become asymmetric between the side closer to the light emitting unit 10 and the side farther from the light emitting unit 10. This is considered to be the cause of the significant distortion.

In an image 201b generated with the optical deflection apparatus 20b As illustrated in FIG. 12B, toward the center in the X direction, the end portion at +Y side expands to +Y side, and the end portion at −Y side shrinks to +Y side. Distortion including both of the barrel type and the pincushion type in a mixed manner occurs significantly.

In the optical deflection apparatus 20b, the first swing axis Ab is configured to be substantially parallel to the first incidence plane P1b (see FIG. 11). Therefore, scanning performed by the optical deflection part 21b is likely to become asymmetric between the side closer to the light emitting unit 10 and the side farther from the light emitting unit 10. This is considered to be the cause of the significant distortion.

In contrast, in the optical deflection apparatus 20 according to the present embodiment, the first swing axis A is configured to be substantially perpendicular to the first incidence plane P1 (see FIG. 7). Therefore, scanning performed by the first optical deflection part 21 is less likely to become asymmetric between the side closer to the light emitting unit 10 and the side farther from the light emitting unit 10.

As a result, as illustrated in FIG. 12C, in the image 201 generated with the optical deflection apparatus 20, distortion is reduced, and the image 201 becomes a non-distorted rectangular image.

<Effects of Optical Deflection Apparatus 20>

Next, the effects of the optical deflection apparatus 20 are explained.

Conventionally, an image projection apparatus projects a two-dimensional image onto a scan-target surface using an optical deflection apparatus that deflects, at a reflection surface, light emitted by a light emitting unit.

However, when the optical deflection apparatus that deflects light by swinging the reflection surface in two directions perpendicular to each other is used, distortion may become significant as illustrated in, for example, the image 201a according to the first comparative example.

Also, it may be considered to employ a configuration including the first optical deflection part that deflects light by swinging the first reflection surface about the first swing axis and the second optical deflection part that deflects light by swinging the second reflection surface about the second swing axis crossing the first swing axis.

In this case, however, when the first swing axis is configured to be substantially parallel to the first incidence plane including the central axis of the light incident on the first reflection surface and the central axis of the light deflected by the first reflection surface, distortion may become significant as illustrated in, for example, the image 201b according to the second comparative example.

It may be considered to correct distortion by applying image processing such as changing the magnification rates in the height and width directions of original image data in order to reduce the distortion caused by the optical deflection apparatus. However, due to the image processing, the resolution of the image may decrease, the angle of view of the projected image may decrease, or moiré (interference fringes) may occur in the projected image.

For example, Japanese Patent No. 5492765 discloses a configuration including a first deflector that deflects light into a first direction and a scanning optical system provided between the first deflector and a scan-target surface in order to reduce TV distortion and trapezoidal distortion of the projected image.

However, in the configuration of Japanese Patent No. 5492765, an optical deflection apparatus such as a first deflector is provided to be inclined with respect to the scanning optical system, and this may complicate the configuration and the adjustment of the image projection apparatus.

In contrast, the optical deflection apparatus 20 according to the present embodiment includes the first optical deflection part 21 that deflects the incident laser light L1 incident on the first reflection surface 22 by swinging the first reflection surface 22 about the first swing axis A. In addition, the optical deflection apparatus 20 according to the present embodiment includes the second optical deflection part 31 that deflects the reflected laser light L2 reflected by the first reflection surface 22 by swinging the second reflection surface 32 about the second swing axis B crossing the first swing axis A.

Furthermore, the first swing axis A is substantially perpendicular to a first incidence plane P1 that includes the incidence central axis L10 of the incident laser light L1 incident on the first reflection surface 22 and the reflection central axis L20 of the reflected laser light L2 reflected by the first reflection surface 22. The second swing axis B is substantially perpendicular to the second incidence plane P2 including the reflection central axis L20 of the reflected laser light L2 incident on the second reflection surface 32 and the output central axis L30 of the output laser light L3 reflected by the second reflection surface 32.

According to this configuration, scanning performed by the first optical deflection part 21 is less likely to become asymmetric between the side closer to the light emitting unit 10 and the side farther from the light emitting unit 10. Furthermore, scanning performed by the second optical deflection part 31 is less likely to become asymmetric between the side closer to the first reflection surface 22 and the side farther from the first reflection surface 22.

As a result, the distortion of the projected image 201 can be reduced. The effect of reducing the distortion can be obtained by simply optimizing the arrangement of the first optical deflection part 21 and the second optical deflection part 31, and therefore, in the optical deflection apparatus, the mechanism for reducing the distortion of the projected image 201 can be simplified.

In the present embodiment, although, for example, the first swing axis A is substantially perpendicular to the first incidence plane P1 and the second swing axis B is substantially perpendicular to the second incidence plane P2, the present invention is not limited thereto. Any configuration may be adopted so long as the first swing axis A crosses the first incidence plane P1 and the second swing axis B crosses the second incidence plane P2. However, when the angle between the first swing axis A and the first incidence plane P1 is closer to 90 degrees (i.e., the first swing axis A is perpendicular to the first incidence plane P1) and the angle between the second swing axis B and the second incidence plane P2 is closer to 90 degrees (i.e., the second swing axis B is perpendicular to the second incidence plane P2), the effect of reducing the distortion increases, and therefore, it is preferable that the angle between the first swing axis A and the first incidence plane P1 is closer to 90 degrees (i.e., the first swing axis A is preferably perpendicular to the first incidence plane P1) and the angle between the second swing axis B and the second incidence plane P2 is closer to 90 degrees (i.e., the second swing axis B is preferably perpendicular to the second incidence plane P2).

Furthermore, in the present embodiment, image processing for correcting the distortion is not performed on the original image data, and therefore, the configuration of the image projection apparatus can be simplified due to the omission of a computation device for performing the image processing, and in addition, the decrease of the resolution and the decrease of the angle of view of the image that would otherwise be caused by the image processing can be alleviated, and an occurrence of moiré can be alleviated.

In the image projection apparatus 100 according to the present embodiment, an image is projected by laser light scanned by the optical deflection apparatus 20 without using the scanning optical system. Therefore, the distortion can be alleviated by employing such a simple configuration without using a scanning optical system.

Note that the optical deflection apparatus 20 can be applied to an image projection apparatus using a scanning optical system. In this case, complicated arrangement and adjustment such as inclining the optical deflection apparatus 20 with respect to the scanning optical system are unnecessary, and therefore, the configuration of the image projection apparatus can be simplified.

In the present embodiment, the scan center laser light 63 passing through the center of the scan angle range η₁ of scanning performed by the first optical deflection part 21 is incident on the second reflection surface 32 from the direction substantially perpendicular to the second swing axis B.

According to this configuration, even in a case where the reflected laser light L2 is scanned by the first optical deflection part 21, the second incidence plane P2, formed by the scanned reflected laser light L2, and the second swing axis B are brought closer to such a state that the second incidence plane P2 and the second swing axis B are perpendicular to each other. Therefore, the mechanism for alleviating the distortion of the image 201 can be simplified.

In the present embodiment, the first optical deflection part 21 deflects the incident laser light L1 incident on the first reflection surface 22, so that the incident laser light L1 is scanned in the direction along the second swing axis B on the second reflection surface 32. According to this configuration, the second swing axis B can be configured to cross the second incidence plane P2 in a preferable manner.

In the present embodiment, the inclination of the second swing axis B with respect to the first reflection surface 22 that is not swinging is 25.5 degrees or more and 34.5 degrees or less. The inclination of the first swing axis A with respect to the second reflection surface 32 that is not swinging is 30.5 degrees or more and 39.5 degrees or less.

According to this configuration, the first swing axis A can be configured to cross the first incidence plane P1 in a preferable manner, and also, the second swing axis B can be configured to cross the second incidence plane P2 in a preferable manner.

Although the embodiment has been described above, the present invention is not limited to the above-described embodiment, and various modifications and changes can be made without departing from the subject matter described in the claims.

In this case, for applications such as a head-up display or a head-mounted display, a hologram optical system may be used. The hologram optical system diffracts the light incident on a diffractive optical element (DOE) to allow a user to visually recognize a real image or a virtual image.

If there is distortion when the scanned light is incident on the DOE, the incidence angle of the scanned light to the DOE deviates from a desired angle, and the quality of the real image or the virtual image seen by the user may decrease.

The optical deflection apparatus and the image projection apparatus according to the present embodiment can reduce the distortion in a preferable manner, and therefore, the scanned light can be configured to be incident at the desired angle, and the reduction in the quality of the real image or the virtual image seen by the user using the hologram optical system can be alleviated. Therefore, the optical deflection apparatus and the image projection apparatus according to the present embodiment can be particularly preferably applied to applications using the hologram optical system.

The numbers such as ordinal numbers and quantities used in the explanation of the embodiment are all shown as examples to specifically explain the techniques related to the present disclosure, and the present invention is not limited to the numbers shown in the examples. Also, the connection relationships between components are shown as examples to specifically explain the techniques of the present disclosure, and the connection relationships that achieve the function of the present disclosure are not limited thereto.

What is claimed is:

1. An optical deflection apparatus comprising:
a first optical deflection part configured to deflect light incident on a first reflection surface, by swinging the first reflection surface about a first swing axis; and
a second optical deflection part configured to deflect the light deflected by the first reflection surface, by swinging a second reflection surface about a second swing axis crossing the first swing axis,
wherein the first swing axis crosses a first incidence plane including a central axis of the light incident on the first reflection surface and a central axis of the light deflected by the first reflection surface, and
the second swing axis crosses a second incidence plane including a central axis of the light incident on the second reflection surface and a central axis of the light deflected by the second reflection surface.

2. The optical deflection apparatus according to claim 1, wherein the first swing axis crosses the first incidence plane to be perpendicular to the first incidence plane, and
the second swing axis crosses the second incidence plane to be perpendicular to the second incidence plane.

3. The optical deflection apparatus according to claim 1, wherein the first optical deflection part scans the light in a direction along the second swing axis on the second reflection surface by deflecting the light incident on the first reflection surface.

4. The optical deflection apparatus according to claim 1, wherein the light passing through a center of a scan angle range of the first optical deflection part is incident on the second reflection surface from a direction crossing the second swing axis.

5. The optical deflection apparatus according to claim 1, wherein an inclination of the second swing axis with respect to the first reflection surface that is not swinging is 25.5 degrees or more and 34.5 degrees or less.

6. The optical deflection apparatus according to claim 1, wherein an inclination of the first swing axis with respect to the second reflection surface that is not swinging is 30.5 degrees or more and 39.5 degrees or less.

7. An image projection apparatus comprising:
a light emitting unit emitting light; and
the optical deflection apparatus according to claim 1,
wherein the image projection apparatus projects an image onto a scan-target surface by causing the optical deflection apparatus to scan the light.

8. The image projection apparatus according to claim 7, wherein the optical deflection apparatus scans, on the scan-target surface, the light in two directions that are a direction along a gravity direction and a direction crossing the gravity direction.
